(19) United States
(12) Patent Application Publication
(10) Pub. No.: US 2008/0244222 A1
(43) Pub. Date: Oct. 2, 2008

(54) MANY-CORE PROCESSING USING VIRTUAL PROCESSORS

(75) Inventors: Alexander V. Supalov, Erftstadt (DE); Hans-Christian Hoppe, Bonn (DE); Linda J. Rankin, Portland, OR (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/694,432

(22) Filed: Mar. 30, 2007

(51) Int. Cl. G06F 15/00

(52) U.S. Cl. 712/13; 712/E09.001

(57) ABSTRACT

The present disclosure provides a method for virtual processing. According to one exemplary embodiment, the method may include partitioning a plurality of cores of an integrated circuit (IC) into a plurality of virtual processors, the plurality of virtual processors having a framework dependent upon a programming application. The method may further include performing at least one task using the plurality of cores. Of course, additional embodiments, variations and modifications are possible without departing from this embodiment.

### FIELD

The present disclosure describes a many-core processing technique using virtual processors.

### BACKGROUND

Programming a many-core processor has proven to be a difficult challenge. There are often too many processors involved to perform adequate threading and each processor may be too slow to allow for reasonable message passing. Moreover, the amount of memory bandwidth available to these small processors may be insufficient. A variety of different programming languages (e.g., Co-array Fortran, Unified Parallel C (UPC), Chapel, X10, Fortress) have emerged for programming parallel systems based on many-core processors and comparable designs. Many of these languages are unproven in this area and present a variety of difficulties for those in the field.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a diagram of an integrated circuit in accordance with one exemplary embodiment of the present disclosure;

FIG. 2 is a diagram of a plurality of virtual processors in accordance with yet another exemplary embodiment of the present disclosure;

FIG. 3 is a diagram of a plurality of virtual processors in accordance with an additional exemplary embodiment of the present disclosure;

FIG. 4 is a diagram of a system in accordance with an exemplary embodiment of the present disclosure; and

FIG. 5 is a diagram showing another exemplary embodiment depicting operations in accordance with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides a system and method for partitioning a many-core processor. This disclosure describes the dynamic partitioning of a many-core integrated circuit (IC) in order to adapt the IC to the most convenient programming model for a particular application. This hardware-based approach may alleviate the programming challenges inherent in dealing with a many-core processor (i.e., minimizing the need for programmers to learn new languages or new paradigms).

The term “integrated circuit”, as used in any embodiment herein, may refer to a semiconductor device and/or microelectronic device, such as, for example, but not limited to, a semiconductor integrated circuit chip. The term “die” as used in any embodiment herein, may refer to a block of semiconducting material, on which a circuit may be fabricated.

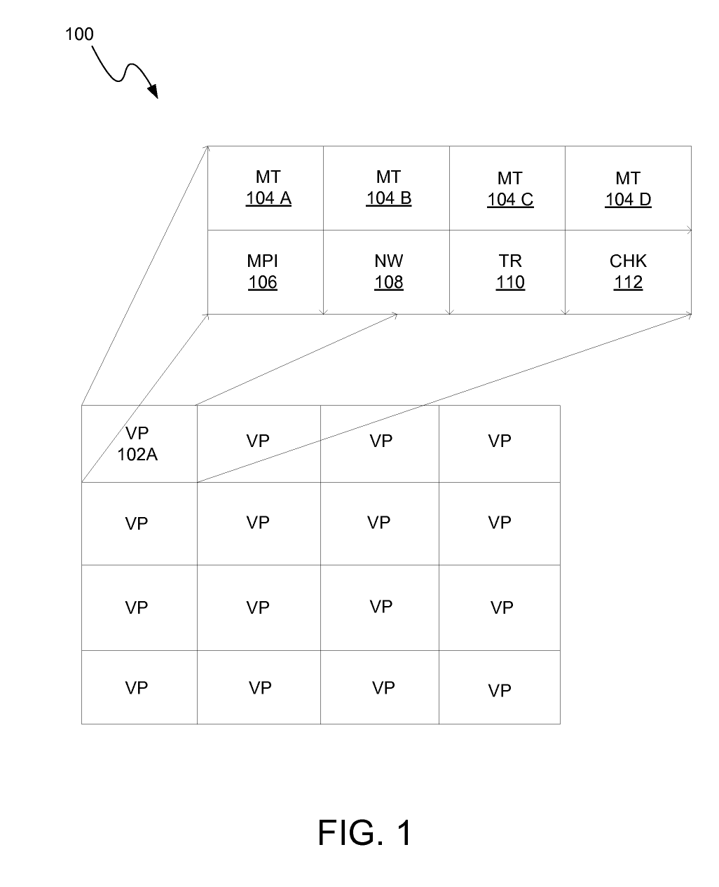

Referring now to FIG. 1, an exemplary embodiment of an IC 100 having a plurality of virtual processors 102 is shown. IC 100 may include a number of virtual 8-core processors 102 located on an 8×16 core die. Of course, this configuration is merely exemplary of one possible embodiment. The particular framework (i.e., the exact number of virtual processors, the number of cores they contain and their particular function) chosen may be altered depending upon the application.

In some embodiments each virtual processor (e.g., 102A) may include a plurality of different cores. For example, virtual processor 102A may include at least one multi-threaded core (MT) 104 configured to execute user threaded code. MT cores 104 may be configured to improve efficiency via simultaneous multi-threading and/or other threading techniques. Virtual processor 102A may further include at least one core configured to handle message transfer (MPI) 106. MPI core 106 may be configured to provide the transfer of a variety of different message forms such as data packets, function invocation, etc. Processor 102A may also include at least one network traffic core (NW) 108 configured to handle traffic management tasks such as class of service (CoS), quality of service (QoS), signals, etc. Processor 102A may further include a few cores configured to process additional operations including, but not limited to, tracing, system monitoring, security, etc. Examples of the tracing core (TR) 110 and system monitoring core (CHK) 112 are shown in FIG. 1.

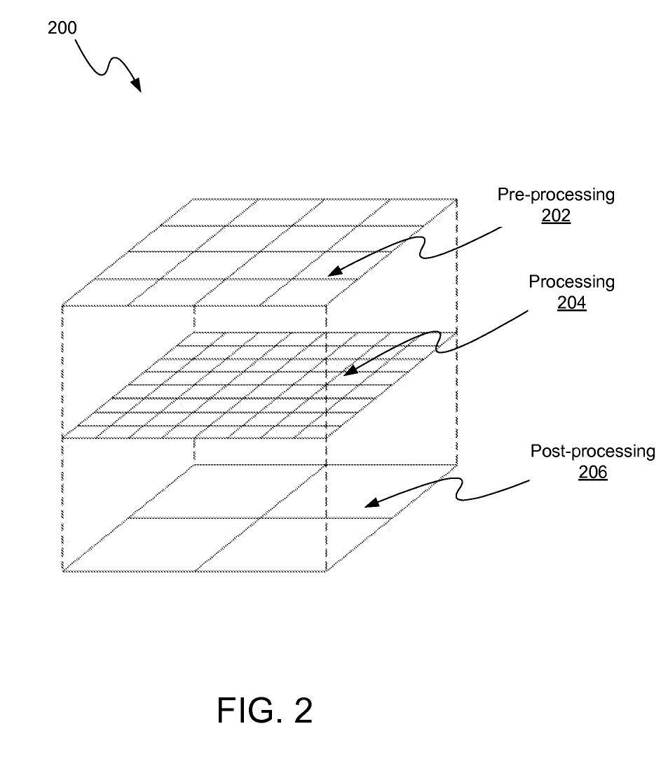

In some embodiments, the number of cores, their configuration, function and physical layout on the die may change according to the program flow. Referring now to FIG. 2, an exemplary embodiment of a diagram 200 depicting an IC having a plurality of virtual processors during the pre-processing, processing and post-processing phases of a particular program is shown.

During pre-processing stage 202, a number of virtual processors may be created out of the core field. For example, the core field may be partitioned into 16 8-core virtual processors as shown in FIG. 2. An application programming interface (API) such as Open Multi-Processing (OpenMP) or Portable Operating System Interface (POSIX) may be used within the virtual processors. In some embodiments, messaging models, including, but not limited to Message Passing Interface (MPI), Cluster OpenMP, Common Object Request Broker Architecture (CORBA), Java Remote Method Invocation (RMI), Service Oriented Architecture (SOA) communication layers, and Hypertext Transfer Protocol (HTTP), may be used to communicate between each virtual processor located within the die as well as with those located outside of the die boundaries.

During processing stage 204, the die may be dynamically repartitioned into a different configuration. For example, the die may be partitioned into a large number of two-core virtual processors as shown in FIG. 2. In some embodiments, at least one of the cores may do data pre-fetching into a shared cache, while the other may perform various intensive mathematical operations. As described above, processing stage 204 may utilize a variety of different configurations in accordance with this disclosure. For example, depending on the programming mode selected, the partition may resemble a systolic array or other arrangement.

Once processing stage 204 is finished, the die may enter a post-processing phase 206. During post-processing stage 206 the die may be repartitioned into a powerful virtual processing field to post-process the data using an algorithm based on a threading and/or message passing programming model. Of course, numerous additional techniques may also be used without departing from the scope of the present disclosure.

In some embodiments, only certain critical aspects of a given computation may need to be reformulated to take advantage of the many-core nature of the die. Some less critical computations may be performed using various software models known in the art. In this way, the adaptable nature of the hardware described herein may simplify the programming of a many-core processor. Further, the reduction of the number of physical cores used in the processing of user data may substantially reduce the memory bandwidth requirements of the associated software. For example, some embodiments described herein may require approximately half of the memory allocation compared to a full set of cores, as only half of the available cores, e.g., MT 104, may be performing active application specific memory read/write operations. In some embodiments, the majority of the data necessary for any inter-core communication may reside in the cache that may be shared between respective cores. This configuration may occur after the virtual processor configuration becomes known by the system. The virtual processors described herein may be in communication with various devices in hardware or software.

In some embodiments, the die may be spatially partitioned to accommodate different components of the application. In this way, individual cores may not have the same architecture, so that the virtual processor approach may be extended to non-uniform many-core systems. These may include systems having differently sized cores, cores having a different system of commands and/or cores having a special purpose architecture. Some of these may include, but are not limited to, networking cores, graphics engines, signal processing cores, reconfigurable cores (e.g., Field Programmable Gate Arrays, etc.). In some embodiments, in order to optimize the flow of communication input cores may be located proximate to input wires and output cores may be located proximate to output wires.

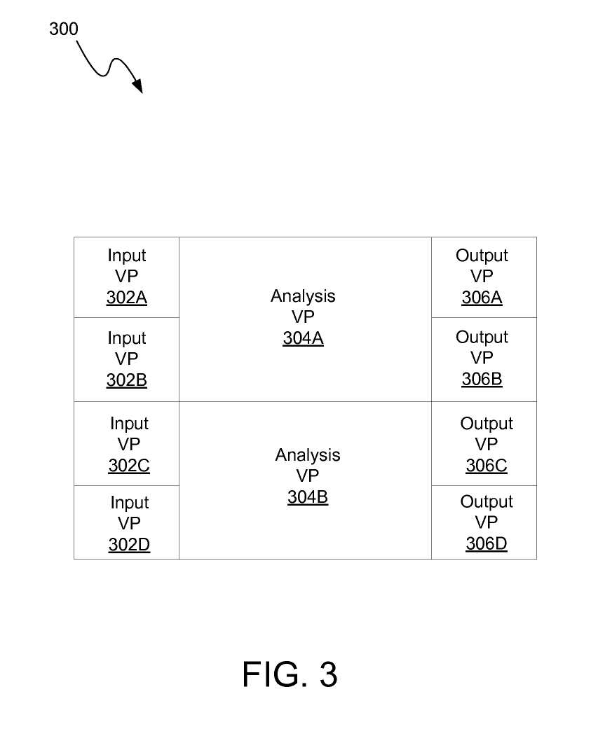

FIG. 3 depicts one embodiment showing the spatial mapping of different application components upon non-uniform virtual processors. For example, in a distributed financial application, a field of smaller input virtual processors 302A-D may handle the processing of input from many tickers into an internal format. This data may be sent to at least one larger analysis virtual processor (e.g., 304A and B). Processors 304A and B may analyze this intermediate internal data and produce relevant results for subsequent operations or display. A set of small output virtual processors 306A-D may handle rendering the analysis results on the trader's workstation. Moreover, system specific services (e.g., overall virtual processing management, system monitoring and checkpoint/restart, etc.) may be delegated to special service virtual processors that may be created if necessary.

The virtual processor approach described herein may allow existing legacy programming languages and paradigms to be used without requiring additional effort. This disclosure may actually simplify the introduction of some programming languages having partitioned global address space (e.g., Fortress, X10, and Chapel). The embodiments described herein may be extended to cover virtual machines (VM), virtual operating system (OS) partitions, and other comparable entities. For example, partitioning may occur via a number of different entities, including, but not limited to, virtual machines, virtual operating systems, and application programs. Further, the partitioning may be performed by and/or may have an affect upon these entities.

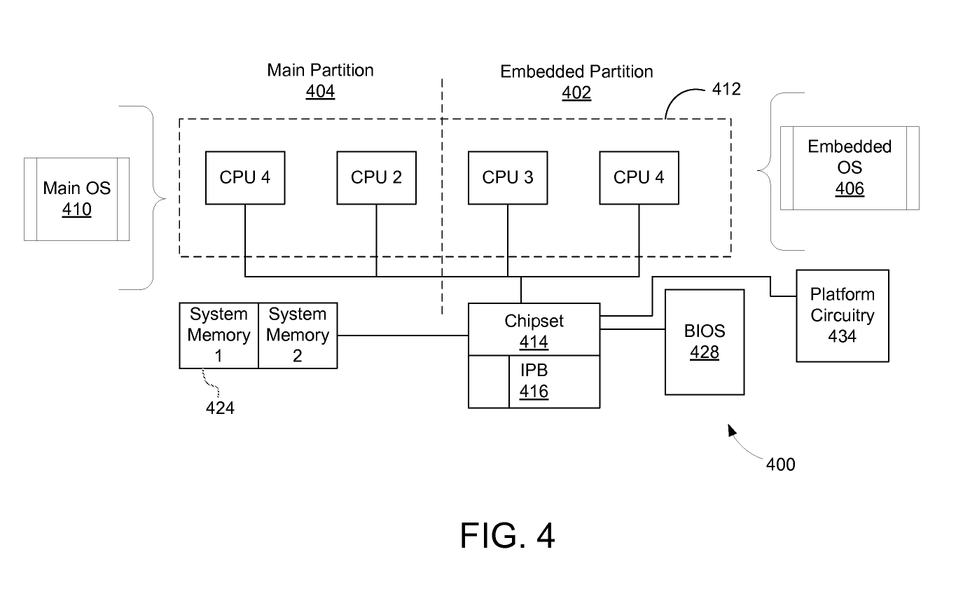

The methodology of FIGS. 1-3 may be implemented, for example, in a variety of multi-threaded processing environments. For example, FIG. 4 is a diagram illustrating one exemplary system embodiment 400, which may be configured to include aspects of any or all of the embodiments described herein.

In some embodiments, system 400 may include a multi-core processor 412, chipset 414 and system memory 421. Multi-core processor 412 may include any variety of processors known in the art having a plurality of cores, for example, an Intel® Pentium® D dual core processor commercially available from the Assignee of the subject application. However, this processor is provided merely as an example, and the operative circuitry described herein may be used in other processor designs and/or other multi-threaded integrated circuits. Multi-core processor 412 may comprise an integrated circuit (IC), such as a semiconductor integrated circuit chip.

In this embodiment, the multi-core processor 412 may include a plurality of core CPUs, for example, CPU1, CPU2, CPU3 and CPU4. Of course, as described above, additional or fewer processor cores may be used in this embodiment. The multi-core processor 412 may be logically and/or physically divided into a plurality of partitions as described in detail above. For example, in this embodiment, processor 412 may be divided into a main partition 404 that includes CPU1 and CPU2, and an embedded partition 402 that includes CPU3 and CPU4. The main partition 404 may be capable of executing a main operating system (OS) 410, which may include, for example, a general operating system such as Microsoft® Windows® XP, commercially available from Microsoft Corporation, and/or other “shrink-wrap” operating system such as Linux, etc.

System memory 421 may comprise one or more of the following types of memories: semiconductor firmware memory, programmable memory, non-volatile memory, read only memory, electrically programmable memory, random access memory, flash memory (which may include, for example, NAND or NOR type memory structures), magnetic disk memory, and/or optical disk memory. Either additionally or alternatively, memory 421 may comprise other and/or later-developed types of computer-readable memory. Machine-readable firmware program instructions may be stored in memory 421. These instructions may be accessed and executed by the main partition 404 and/or the embedded partition 402 of host processor 412. In some embodiments, memory 421 may be logically and/or physically partitioned into system memory 1 and system memory 2. System memory 1 may be capable of storing commands, instructions, and/or data for operation of the main partition 404, and system memory 2 may be capable of storing commands, instructions, and/or data for operation of the embedded partition 402.

Chipset 414 may include integrated circuit chips, such as those selected from integrated circuit chipsets commercially available from the assignee of the subject application (e.g., graphics memory and I/O controller hub chipsets), although other integrated circuit chips may also, or alternatively be used. Chipset 414 may include inter-partition bridge (IPB) circuitry 416. “Circuitry”, as used in any embodiment herein, may comprise, for example, singly or in any combination, hardwired circuitry, programmable circuitry, state machine circuitry, and/or firmware that stores instructions executed by programmable circuitry. The IPB 416 may be capable of providing communication between the main partition 404 and the embedded partition 402. In alternative embodiments, the chipset 414 and/or IPB 416 may be incorporated into the host processor 412. Further, the IPB 416 may be configured as a shared memory buffer between the main partition 404 and the embedded partition 402 and/or interconnect circuitry within, for example, chipset 414.

System 400 may also include system built-in operating system (BIOS) 428 that may include instructions to configure the system 400. In this embodiment, BIOS 428 may include instructions to configure the main partition 404 and the embedded partition 402 in a manner described herein using, for example, platform circuitry 434. Platform circuitry 434 may include platform resource layer (PRL) instructions that, when instructed by BIOS 428, may configure the host processor into partitions 402 and 404 and sequester one or more cores within each partition. The platform circuitry 434 may comply or be compatible with CSI (common system interrupt), Hypertransport™ (HT) Specification Version 3.0, published by the HyperTransport™ Consortium and/or memory isolation circuitry such as memory isolation circuitry such as a System Address Decoder (SAD) and/or Advanced Memory Region Registers (AMRR)/Partitioning Range Register (PXRR). This circuitry may be used, for example, to isolate the embedded partition 402 from the main partition 404 and/or to split system memory 421 to independently service the embedded partition 402 and the main partition 404, respectively.

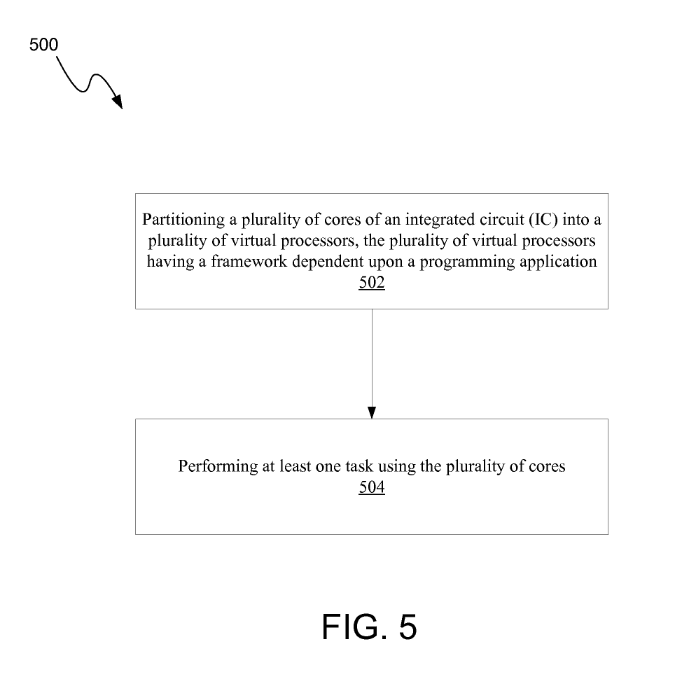

FIG. 5 depicts a flowchart 500 of exemplary operations consistent with the present disclosure. Operations may include partitioning a plurality of cores of an integrated circuit (IC) into a plurality of virtual processors, the plurality of virtual processors having a quantity dependent upon a programming application (502). Operations may further include performing at least one task using the plurality of cores (504). Of course additional operations are also within the scope of the present disclosure.

It should be understood that any of the operations and/or operative components described in any embodiment herein may be implemented in software, firmware, hardwired circuitry and/or any combination thereof. For example, hardware support may be provided in the form of dynamic repartitioning of the cache areas to create shared, possibly unmapped cache and/or in the form of direct interconnections within the virtual processor.

Embodiments of the methods described above may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic operations. Other embodiments may be implemented as software modules executed by a programmable control device.

Accordingly, at least one embodiment described herein may provide an apparatus comprising an integrated circuit (IC) having a plurality of cores capable of being partitioned into a plurality of virtual processors. The plurality of virtual processors may have a quantity that may be dependent upon a particular programming application.

The embodiments described herein may provide numerous advantages over the prior art. For example, previous attempts to program many-core systems have required programmers to learn unproven new languages. The virtual processor technique described herein may utilize hardware to meet the established programming models. Further, this approach simplifies the introduction of newer programming languages by reducing the number of computational entities that a programmer must address. This disclosure may be extended to both temporal and spatial repartitioning of a uniform or non-uniform die and may alleviate the issue of the low per core memory bandwidth.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. An apparatus, comprising:
an integrated circuit (IC) having a plurality of cores capable of being partitioned into a plurality of virtual processors, the plurality of virtual processors having a framework dependent upon a programming application.

2. The apparatus according to claim 1, wherein the plurality of cores are configured to perform at least one task, the at least one task selected from the group consisting of multi-threading, message passing, network transfer, tracing, system monitoring, security and interrupt processing.

3. The apparatus according to claim 1, wherein the plurality of cores are partitioned into sixteen 8-core virtual processors during a pre-processing stage, 64 2-core virtual processors during a processing stage and 4 32-core processors during a post-processing stage.

4. The apparatus according to claim 1, wherein the plurality of processors include at least one management processor configured to manage the plurality of virtual processors.

5. The apparatus according to claim 1, wherein the plurality of cores are non-uniformly distributed within the plurality of virtual processors.

6. The apparatus according to claim 1, wherein the plurality of virtual processors are configured to communicate with at least one hardware device.

7. The apparatus according to claim 1, wherein the plurality of cores are spatially partitioned upon the IC.

8. The apparatus according to claim 1, wherein the plurality of cores include a plurality of distinct cores.

9. The apparatus according to claim 8, wherein the plurality of distinct cores is selected from the group consisting of networking cores, graphics engines, signal processing cores and FPGAs.

10. A method comprising:
partitioning a plurality of cores of an integrated circuit (IC) into a plurality of virtual processors, the plurality of virtual processors having a framework dependent upon a programming application; and
performing at least one task using the plurality of cores.

11. The method according to claim 10, wherein the at least one task is selected from the group consisting of multi-threading, message passing, network transfer, tracing, system monitoring, security and interrupt processing.

12. The method according to claim 10, wherein the plurality of cores include a plurality of distinct cores including at least one of networking cores, graphics engines, signal processing cores and FPGAs.

13. The method according to claim 10, further comprising managing the plurality of processors via at least one management processor.

14. The method according to claim 10, further comprising non-uniformly distributing the plurality of cores within the plurality of virtual processors.

15. The method according to claim 10, wherein partitioning is performed by at least one entity selected from the group consisting of virtual machines, virtual operating systems, and application programs, the partitioning capable of having an effect upon the at least one entity.
